(19) United States
(12) Patent Application Publication
(10) Pub. No.: US 2011/0090970 A1
(43) Pub. Date: Apr. 21, 2011

(54) TERMINAL AND RELAY NODE FOR VIDEO CONFERENCE SYSTEM

(75) Inventors: Nac Woo KIM, Gwangju-si (KR); Kyunghun KIM, Gwangju-si (KR); Sim-Kwon YOON, Gwangju-si (KR); Byung-Tak LEE, Gyeonggi-do (KR); Jai Sang KOH, Gwangju-si (KR)

(73) Assignee: Electronics and Telecommunications Research Institute, Daejeon (KR)

(21) Appl. No.: 12/652,118

(22) Filed: Jan. 5, 2010

(30) Foreign Application Priority Data
Oct. 19, 2009 (KR) 10-2009-0099119

(51) Int. Cl. H04N 7/12

(52) U.S. Cl. 375/240.26

(57) ABSTRACT

A terminal, a relay node, and a stream processing method for a video conference system may be provided. A transmitting terminal may receive media data, generate elementary streams from the media data, generate a transport stream by multiplexing the elementary streams, and transmit the transport stream to a relay node associated with a first receiving terminal among receiving terminals.

### CROSS-REFERENCE TO RELATED APPLICATION

This application claims priority from Korean Patent Application No. 10-2009-0099119, filed on Oct. 19, 2009, in the Korean Intellectual Property Office, the entire disclosure of which is incorporated herein by reference.

### BACKGROUND OF THE INVENTION

1. Field of the Invention

The present invention relates to a terminal, a relay node, and a stream processing method for a video conference system.

2. Description of Related Art

In general, a video conference system may use a system supporting a two-dimensional (2D)-based multi-image and a three-dimensional (3D) graphic model, or a method that obtains a 3D stereo image and transmits the image. Accordingly, technologies for time division using a shutter glass, 3D image correction, obtaining of an intermediate image, and synchronization have been developed.

In a 2D or 3D media transmission method in a conventional art, an elementary stream of a multimedia channel including identical temporal and spatial information may be encoded to be suited for a 2D or 3D display environment.

The above-described technologies are advantageous in that a 3D image may be acquired and transmitted to another terminal without image degradation, and the above-described encoding method may focus on encoding and transmitting an individual stream of an image based on a display environment of a user.

### SUMMARY OF THE INVENTION

An aspect of the present invention provides a terminal, a relay node, and a stream processing method that may multiplex a plurality of Elementary Streams (ESs), transmit a transport stream, select a portion of the plurality of ESs in a receiving terminal, and thereby may provide a more efficient video conference service.

Another aspect of the present invention also provides a terminal, a relay node, and a stream processing method that selectively use streams for displaying based on display information of a receiving terminal, and thereby may output an image optimized based on a display environment of each of a plurality of terminals.

Another aspect of the present invention also provides a terminal, a relay node, and a stream processing method that may assign an identifier to each stream, identify each of the streams using the assigned identifier, and thereby may provide an improved Quality of Service (QoS).

Another aspect of the present invention also provides a terminal, a relay node, and a stream processing method that may conduct a video conference using a multiplexed transport stream, and thereby may perform transmission over media using a minimum bandwidth on a network without re-encoding two-dimensional (2D) or three-dimensional (3D) data compressed through a standard encoder.

According to an aspect of the present invention, there is provided a transmitting terminal, including: an input unit to receive media data[this term is used a number of times, but I am not sure what it is describing]; an encoding unit to generate elementary streams from the media data; a multiplexing unit to multiplex the elementary streams and to generate a transport stream; and an interface to transmit the transport stream to a relay node associated with a first receiving terminal among receiving terminals. A customized transport stream including at least one of the elementary streams may be generated from the transport stream through the relay node based on display information of the first receiving terminal.

The multiplexing unit may assign an identifier to each of the elementary streams. The customized transport stream may be generated through the relay node using the identifier.

The multiplexing unit may multiplex the elementary streams into transmission packets different from each other. According to another aspect of the present invention, the multiplexing unit may multiplex the elementary streams into a single packet.

The media data may include images from different viewpoints, and the elementary streams may be generated from the images. According to an embodiment of the present invention, the images may be any one of a two-dimensional (2D) image, stereo images, and multi-view images.

The display information may be periodically received from the first receiving terminal in response to a request to the first receiving terminal or in response to an occurrence of a predetermined event in the first receiving terminal.

The display information may include display device information and display setting information.

The input unit may insert at least one of a virtual object and a virtual background in the media data.

The elementary streams, through the relay node, may be identified from the transport stream, at least one customized elementary stream may be selected from the elementary streams based on the display information of the first receiving terminal, and the customized transport stream may be generated using the customized elementary stream.

According to another aspect of the present invention, there is provided a transmitting terminal, including: an input unit to receive media data; an encoding unit to generate elementary streams from the media data; a multiplexing unit to multiplex the elementary streams and to generate a transport stream; and an interface to generate a customized transport stream including at least one of the elementary streams from the transport stream based on display information of a first receiving terminal among receiving terminals.

According to an aspect of the present invention, there is provided a relay node, including: an information receiving unit to receive display information from a first receiving terminal among receiving terminals; a stream receiving unit to receive a transport stream including elementary streams from a transmitting terminal; a stream processing unit to generate a customized transport stream including at least one of the elementary streams from the transport stream based on the display information; and a stream transmission unit to transmit the customized transport stream to the first receiving terminal.

According to an aspect of the present invention, there is provided a receiving terminal, including: an interface to transmit display information to a relay node, and to receive a customized transport stream from the relay node; a demultiplexing unit to extract a customized elementary stream from the customized transport stream; a decoding unit to decode media data from the customized elementary stream; and an output unit to output the media data. Identification of the elementary streams from the transport stream, selection of at least one customized elementary stream from the elementary streams based on the display information of the first receiving terminal, and generation of the customized transport stream using the at least one customized elementary stream are performed by the relay node.

According to another aspect of the present invention, there is provided a receiving terminal, including: an interface to transmit display information to a transmitting terminal, and to receive a customized transport stream from the transmitting terminal; a demultiplexing unit to extract a customized elementary stream from the customized transport stream; a decoding unit to decode media data from the customized elementary stream; and an output unit to output the media data. Via the transmitting terminal, a transport stream including elementary streams may be generated, at least one customized elementary stream may be selected from the elementary streams based on the display information, and the customized transport stream may be generated using the customized elementary stream.

### BRIEF DESCRIPTION OF THE DRAWINGS

The above and other aspects of the present invention will become apparent and more readily appreciated from the following detailed description of certain exemplary embodiments of the invention, taken in conjunction with the accompanying drawings of which:

FIG. 1 is a diagram illustrating a relationship of a transmitting terminal, relay nodes, and receiving terminals according to an embodiment of the present invention;

FIG. 2 is a block diagram illustrating a configuration of a transmitting terminal according to an embodiment of the present invention;

FIG. 3 is a diagram illustrating streams according to an embodiment of the present invention;

FIG. 4 is a diagram illustrating configurations of a transport stream according to an embodiment of the present invention;

FIG. 5 is a diagram illustrating an example of a user interface application program of a receiving terminal according to an embodiment of the present invention;

FIG. 6 is a block diagram illustrating a configuration of a relay node according to an embodiment of the present invention;

FIG. 7 is a block diagram illustrating a configuration of a receiving terminal according to an embodiment of the present invention;

FIG. 8 is a flowchart illustrating a stream processing method according to an embodiment of the present invention; and

FIG. 9 is a flowchart illustrating a stream processing method according to another embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

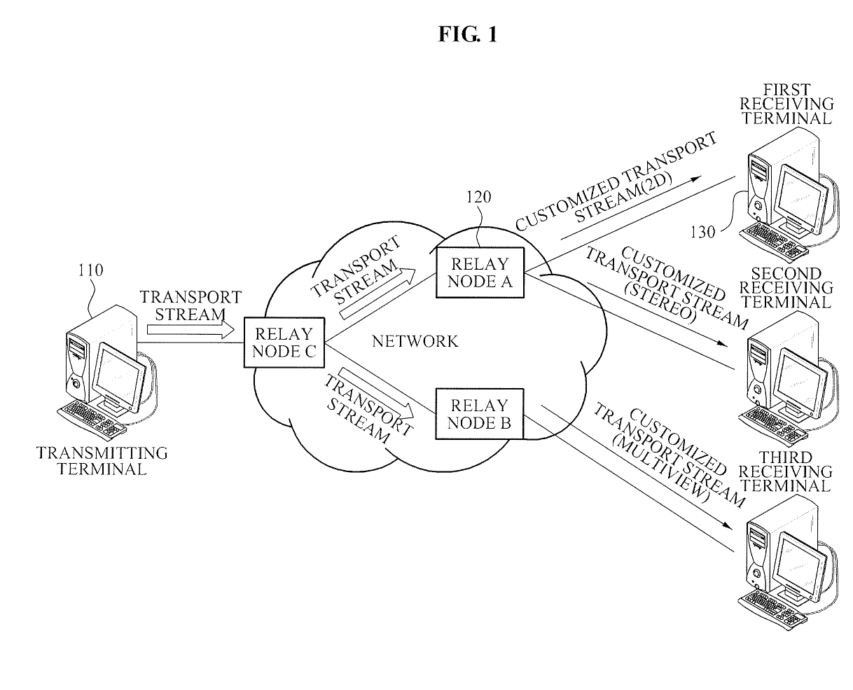

FIG. 1 is a diagram illustrating a relationship of a transmitting terminal, relay nodes, and receiving terminals according to an embodiment of the present invention.

As illustrated in FIG. 1, the transmitting terminal 110 may conduct a video conference with a first receiving terminal 130, a second receiving terminal, and a third receiving terminal. In this instance, media data, obtained from a camera of the transmitting terminal 110, may be decoded into a transport stream and transmitted to the first receiving terminal 130, the second receiving terminal, and the third receiving terminal through a network. Also, the transport stream may be transmitted to the first receiving terminal 130, the second receiving terminal, and the third receiving terminal through relay nodes in the network.

According to an embodiment of the present invention, the transmitting terminal 110 may generate a transport stream by multiplexing a plurality of Elementary Streams (ESs), and transmit the transport stream to a relay node A 120 and a relay node B. The relay node A 120 may receive display information about the first receiving terminal 130 from the first receiving terminal 130. For example, the media data may include an image, and the like.

Also, the relay node A 120 may generate a customized transport stream from the transport stream based on the display information, and transmit the customized transport stream to the first receiving terminal 130. Through this, the first receiving terminal 130 may output an image suitable for the display information of its own.

For example, the transmitting terminal 110 may receive images from different viewpoints as the media data through the camera, and encode each of the images into the ESs. Also, the transmitting terminal 110 may assign an identifier to each of the ESs, multiplex each of the ESs, and thereby may generate the transport stream. In this instance, the ESs may be encoded from a two-dimensional (2D) image from a single viewpoint, stereo images from left and right viewpoints, or multi-view images from a first through N viewpoints. The relay node A 120 may ascertain that the first receiving terminal 130 supports displaying a 2D image based on the display information of the first receiving terminal 130. Also, the relay node A 120 may generate the customized transport stream based on any one ES in the transport stream. The first receiving terminal 130 may receive the customized transport stream instead of the transport stream including the ESs, decode the 2D image based on the received customized transport stream, and output the decoded 2D image.

The transmitting terminal 110 may transmit the transport stream to the relay node B. The relay node B may identify that the third receiving terminal supports displaying a multi-view image based on display information of the third receiving terminal. Also, the relay node B may generate a customized transport stream based on N ESs in the transport stream. Also, the third receiving terminal may decode the multi-view image based on the received customized transport stream, and output the decoded multi-view image. As described above, since each of the receiving terminals may receive a portion of ESs depending on its own display environment, a user convenience and a network environment may be improved.

According to an embodiment of the present invention, the transport stream and the customized transport stream may include a virtual object for Augmented Reality (AR) or a 3D background for virtual reality. Here, the virtual object and the 3D background may be inserted by the transmitting terminal 110.

According to an embodiment of the present invention, the transmitting terminal 110 may include an input unit, an encoding unit, a multiplexing unit, and an interface. The input unit may receive media data, the encoding unit may generate ESs from the media data, and the multiplexing unit may generate a transport stream by multiplexing the ESs. The interface may transmit the transport stream to a relay node associated with a first receiving terminal among receiving terminals.

Also, according to an embodiment of the present invention, the first receiving terminal 130 may include an interface, a demultiplexing unit, a decoding unit, and an output unit. The interface may transmit display information to a relay node, and receive a customized transport stream from the relay node. The demultiplexing unit may extract a customized ES from the customized transport stream, and the decoding unit may decode media data from the customized ES. The output unit may output the media data.

Also, the transmitting terminal 110 and the receiving terminals may be interchangeable due to interactivity of video conference. That is, the first receiving terminal 130 may be a transmitting terminal to transmit an image of the first receiving terminal 130 to another terminal. For example, each of the transmitting terminal 110, the first receiving terminal 130, the second receiving terminal, and the third receiving terminal, illustrated in FIG. 1, may be a bidirectional content receiving/transmitting device where a receiving end and a transmission end are not fixed. Accordingly, when the transmitting terminal 110, the first receiving terminal 130, the second receiving terminal, and the third receiving terminal conduct a video conference, each of the transmitting terminal 110, the first receiving terminal 130, the second receiving terminal, and the third receiving terminal may simultaneously perform as a transmitting terminal to transmit the transport stream and a receiving terminal to receive the customized transport stream.

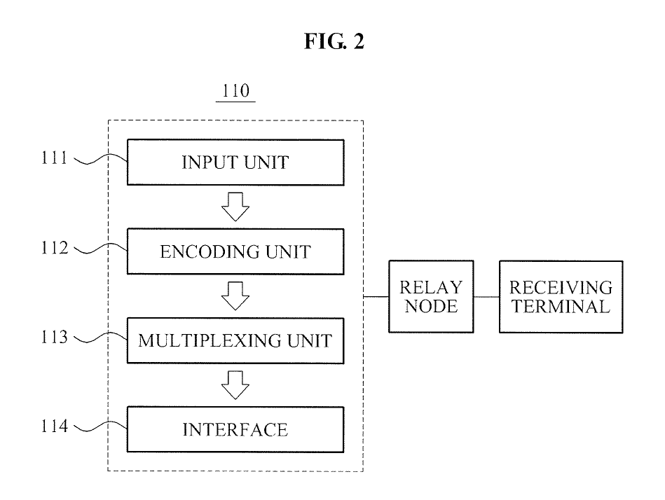

Hereinafter, an operation of each of the transmitting terminal 110, the relay node A 120, and the first receiving terminal 130 are further described with reference to FIGS. 2 through 9.

FIG. 2 is a block diagram illustrating a configuration of the transmitting terminal 110 according to an embodiment of the present invention.

As illustrated in FIG. 2, the transmitting terminal 110 may include an input unit 111, an encoding unit 112, a multiplexing unit 113, and an interface 114.

The input unit 111 may receive media data. In this instance, the media data may be inputted from at least one camera module. Also, the media data may be an inputted 2D image or 3D image for a video conference and a seminar. Also, the media data may include images from different viewpoints. In this instance, the images may be any one of a 2D image, stereo images, and multi-view images. For example, the media data may be a 2D image configured as an image from a single viewpoint, stereo images configured as images from dual viewpoints, or multi-view images configured as images from at least three viewpoints.

Also, the input unit 111 may insert at least one of a virtual object and a virtual background in the media data. For example, the input unit 111 may insert a 3D virtual background for virtual reality in the media data, and insert a virtual object for AR in the media data. Accordingly, when the transmitting terminal 110 inserts the virtual background and the virtual object in the media data, the receiving terminal may use the virtual background and the virtual object in real-time by outputting or downloading using an application program for the virtual background and the virtual object.

The encoding unit 112 may generate ESs from the media data. In this instance, the media data may include images from different viewpoints, and the ESs may be generated from the images. For example, the media data may include a first viewpoint image through a fifth viewpoint image, and the ESs may include a first ES through a fifth ES. The first ES may be encoded from the first viewpoint image and the fifth ES may be encoded from the fifth viewpoint image. Similarly, the ESs may include a first ES and a second ES. Here, the first ES may be encoded from a left viewpoint image, the second ES may be encoded from a right viewpoint image, and the left viewpoint image and the right viewpoint image may be stereo images.

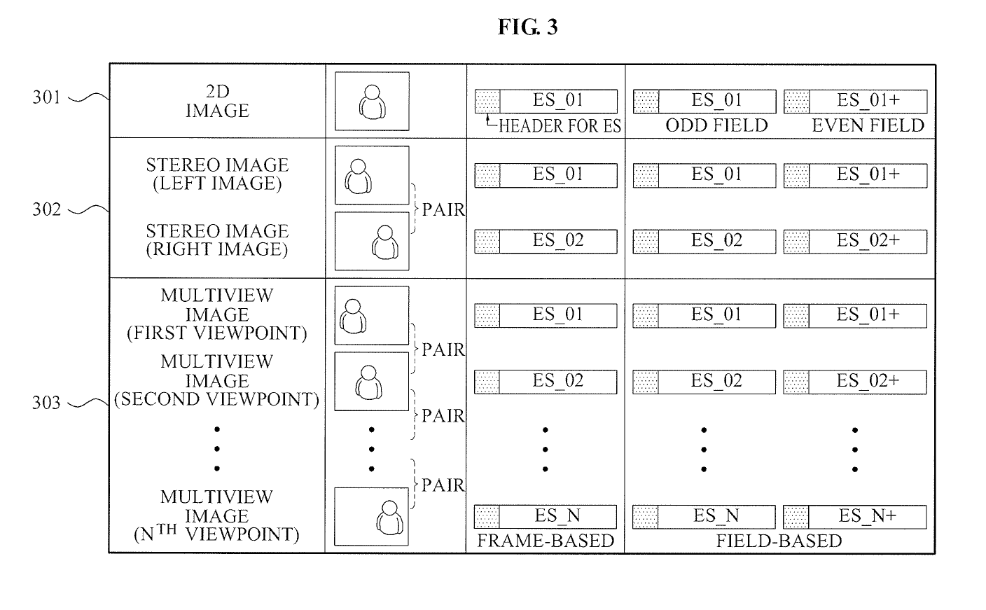

FIG. 3 is a diagram illustrating streams according to an embodiment of the present invention.

Referring to FIG. 3, a 2D image 301 may be configured as a single ES, stereo images 302 may be configured as two ESs with respect to left and right images, and multi-view images 303 having N viewpoints may be configured as N ESs with respect to N−1 pairs. In this instance, as illustrated in FIG. 3, there may be twice as many field-based ESs as frame-based ESs.

Also, the ESs may be decoded into the media data. For example, when a first ES through a tenth ES from different viewpoints exist, each of the first ES through the tenth ES may be decoded into a first 2D image through a tenth 2D image. Also, a third ES and a seventh ES from among the first ES through the tenth ES may be decoded into a left viewpoint image and a right viewpoint image from among the stereo images, respectively. Also, the first ES through the tenth ES may be decoded into multi-view images. In this instance, the multi-view images may be converted into a 3D image.

Also, the media data may be inputted from a single or a plurality of camera modules, and the encoding unit 112 may generate the ESs by composing, editing, and encoding the inputted media data. Also, according to an embodiment of the present invention, the encoding unit 112 may generate the ESs based on display information of receiving terminals. In this instance, the display information may be display device information or display setting information of the receiving terminals.

Specifically, the encoding unit 112 may obtain format information of an image, that may be outputted by the receiving terminals, based on the display information of the receiving terminals, and generate the ESs. For example, when a first receiving terminal through a third receiving terminal may be included in the receiving terminals, the first receiving terminal supports a 2D image format having a single viewpoint, the second receiving terminal supports a stereo image format having dual viewpoints, and the third receiving terminal supports a multi-view image format having ten viewpoints, the encoding unit 112 may generate ten ESs from images having the ten viewpoints. In this instance, each of the ten ESs may be decoded into a 2D image from a single viewpoint, into stereo images from dual viewpoints, or into multi-view images from ten viewpoints. Also, the display information may be periodically received from the receiving terminals in response to a request to the receiving terminals or in response to an occurrence of a predetermined event in the receiving terminals.

The multiplexing unit 113 may multiplex the ESs and generate a transport stream.

Also, the multiplexing unit 113 may assign an identifier to each of the ESs, and generate the transport stream. For example, the identifier may include a Packet ID (PID) of a Moving Picture Experts Group 2 Transport Stream (MPEG2-TS) system, a stream_id of an MPEG2 Packetized Elementary Stream (PES), and a stream_type of an MPEG4 ES_descriptor.

Also, according to an embodiment of the present invention, the multiplexing unit 113 may multiplex the ESs into transmission packets, different from each other, to generate the transport stream. Also, according to another embodiment of the present invention, the multiplexing unit 113 may multiplex the ESs into a single packet, to generate the transport stream.

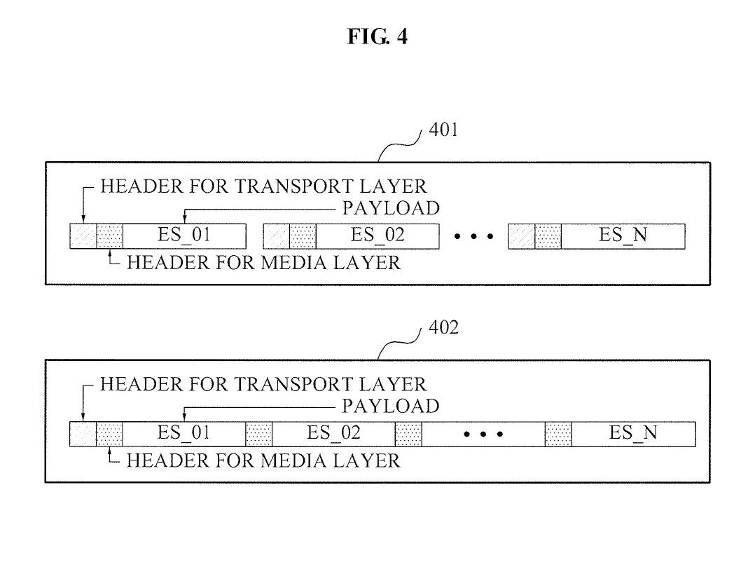

FIG. 4 is a diagram illustrating configurations of a transport stream according to an embodiment of the present invention.

Referring to a diagram 401 of FIG. 4, the multiplexing unit 113 may generate the transport stream by multiplexing each of the ESs into the transmission packets different from each other (unique transmission packets). Also, as illustrated in a diagram 402 of FIG. 4, the multiplexing unit 113 may generate the transport stream by multiplexing the ESs into a single packet. In this instance, each transmission packet of the diagram 401 may include each of the ESs and a unique header for a transport layer. Also, the transmission packet of the diagram 402 may include a plurality of ESs, and each of the plurality of ESs may include a unique header for a media layer.

The interface 114 may transmit the transport stream to the relay node 120 associated with the first receiving terminal 130 among receiving terminals. In this instance, the relay node 120 may generate a customized transport stream from the transport stream based on display information of the first receiving unit 130. Here, the customized transport stream may include at least one of the ESs. Specifically, the relay node 120 may identify the ESs from the transport stream, and select at least one customized ES from the ESs based on the display information of the first receiving unit 130. Also, the relay node 120 may generate the customized transport stream using the customized ES. In this instance, the relay node 120 may identify the ESs using an identifier, and generate the customized transport stream.

For example, the interface 114 may transmit a transport stream, multiplexed from a first ES through a tenth ES, to the relay node 120. The first ES through the tenth ES may be generated from images from ten viewpoints. In this instance, the relay node 120 may identify the first ES through the tenth ES from the transport stream through the identifier, generate a customized transport stream based on the display information of the first receiving terminal 130, and transmit the customized transport stream to the first receiving terminal 130. Here, the customized transport stream may include any one of the first ES through the tenth ES. That is, the relay node 120 may generate a customized transport stream, optimized for the first receiving terminal 130, from the transport stream. Also, the customized transport stream may be periodically or adaptively generated, and transmitted to the first receiving terminal 130.

Also, the relay node 120 may generate a customized transport stream including only two ESs from among the first ES through the tenth ES, or generate a customized transport stream including all the ESs from the first ES to the tenth ES. In this instance, when the customized transport stream including only two ESs is received, the first receiving terminal 130 may decode a stereo image using the customized transport stream. Also, when the customized transport stream including all the ESs is received, the first receiving terminal 130 may decode a multi-view image using the customized transport stream. Also, the customized transport stream may include at least one of an ES generated from a 2D image, ESs generated from stereo images, and ESs generated from multi-view images.

Referring again to FIG. 3, the relay node 120 may transmit a single ES 301 to a receiving terminal including a 2D image display device, two ESs 302 to a receiving terminal including a stereo image display device, and N ESs 303 to a receiving terminal including a multi-view image display device. In this instance, the single ES, the two ESs, and the N ESs may be a frame-based ES. Also, the single ES and the two ESs may be a portion of the N ESs.

Also, the relay node 120 may identify the ESs from the transport stream based on an identifier analysis. For example, the identifier analysis may include an analysis of an identifier recorded in a header for a transport layer, and an analysis of an identifier recorded in a header for a media layer. For example, the identifier analysis through the header for the transport layer may include a PID of MPEG2-TS system, and the identifier analysis through the header for the media layer may include a stream_id of MPEG2 PES, and a stream_type of MPEG4.

Also, the relay node 120 may be a node for relaying or transmitting a stream, and exchange a message with receiving terminals associated with the relay node 120. Also, the relay node 120 may perform media transmission and message exchange with another node. Also, the interface 114 may obtain display device information from a display device in the transmitting terminal 110. Also, the interface 114 may receive/transmit display information and the transport stream in interoperation with the relay node 120 and receiving terminals through a network.

Also, the relay node 120 may periodically receive the display information from the first receiving terminal 130 in response to a request to the first receiving terminal 130 or in response to an occurrence of a predetermined event in the first receiving terminal 130. Also, the display information may include display device information and display setting information. Accordingly, the relay node 120 may analyze an ES, supported by the first receiving terminal 130, based on the display device information received from the first receiving terminal 130, and thereby may generate the customized transport stream from the transport stream. Also, the relay node 120 may generate the customized transport stream based on the display setting information. In this instance, the display setting information may be information associated with display output of the first receiving terminal 130. That is, the display information may be determined based on a display output mode of the first receiving terminal 130. For example, when the first receiving terminal 130 processes all the 2D image, stereo images, and multi-view images, and also outputs of the 2D image selected by a user, the display setting information may request the relay node 120 for an ES generated from an image from a single viewpoint.

Also, the display setting information may include information about selection on an ES of a first viewpoint from among the ESs. Also, the display setting information may be determined based on a viewpoint change command inputted from the user of the first receiving terminal 130. Also, the display setting information may be determined by an interface application program of the first receiving terminal 130.

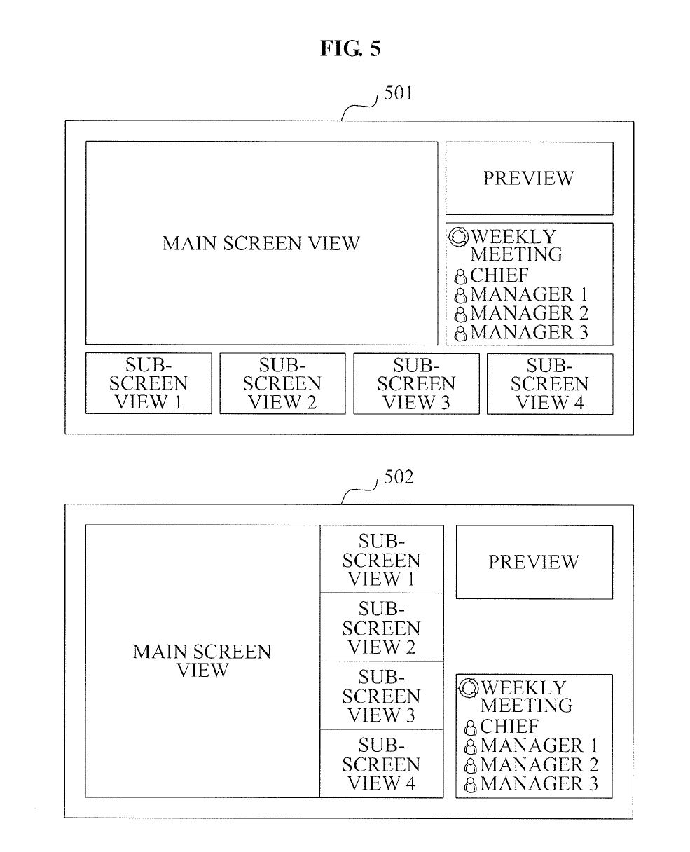

FIG. 5 is a diagram illustrating an example of a user interface application program of a receiving terminal according to an embodiment of the present invention.

As illustrated in FIG. 5, an output screen of a user interface application program may be configured as a screen 501 or a screen 502. In this instance, a main screen may be a window for a chairman of a seminar, and a sub-screen may be a window for a participant. A preview may be used when a program user checks a camera input and a composite image of a virtual background and a virtual object in advance. Also, since a 2D image or a 3D image may be mixed in a screen including the main screen, sub-screen, and preview window, the user interface application program may determine the display setting information to enable only 2D screen to be displayed on a user interface. Also, any one of the main screen and the sub-screen may be extended to a full screen to view a 3D screen. In this instance, the user may use a button for 2D or 3D screen switch in a remote control, or use a mouse click. A current window state of the first receiving terminal 130 may be transmitted as the display setting information through a message communication between the first receiving terminal 130 and the relay node 120, and the relay node 120 may transmit 2D or 3D contents depending on a user interface state of the first receiving terminal 130.

Also, according to an embodiment of the present invention, the interface 114 may generate a customized transport stream from the transport stream based on the display information of the first receiving terminal 130. The customized transport stream may include at least one ES from among the ESs. Specifically, the interface 114 may generate the customized transport stream from the transport stream based on the display information of the first receiving terminal 130, and transmit the customized transport stream to the first receiving terminal 130. Also, the interface 114 may analyze an identifier from the transport stream, and generate the customized transport stream using the identifier. That is, the interface 114 may function as the relay node 120 described above. According to an embodiment of the present invention, the relay node 120 may be included and integrated in the interface 114, or may be a terminal such as a Personal Computer (PC) or a server connected on a Peer to Peer (P2P) network.

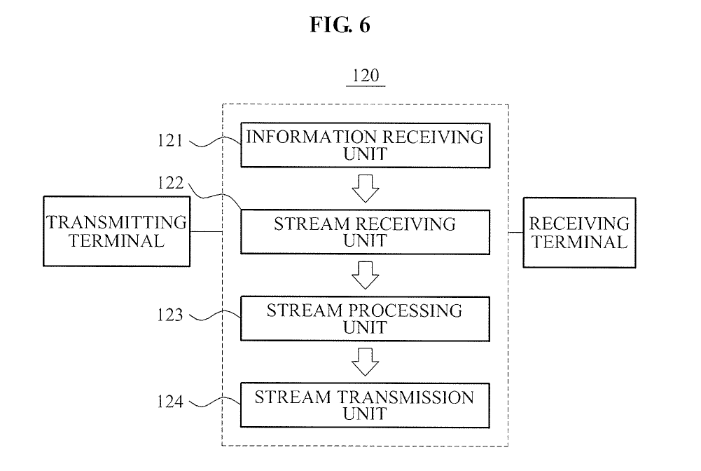

FIG. 6 is a block diagram illustrating a configuration of a relay node 120 according to an embodiment of the present invention.

As illustrated in FIG. 6, the relay node 120 may include the information receiving unit 121, the stream receiving unit 122, the stream processing unit 123, and the stream transmission unit 124.

The information receiving unit 121 may receive display information from the first receiving terminal 130 among receiving terminals.

The stream receiving unit 122 may receive a transport stream including ESs from the transmitting terminal 110.

The stream processing unit 123 may generate a customized transport stream from the transport stream based on the display information. The customized transport stream may include at least one of the ESs.

Specifically, the stream processing unit 123 may identify the ESs from the transport stream, select at least one customized ES from the ESs based on the display information of the first receiving terminal 130, and generate the customized transport stream using the customized ES. In this instance, the customized transport stream may include at least one of an ES generated from a 2D image, ESs generated from stereo images, and ESs generated from multi-view images.

The stream transmission unit 124 may transmit the customized transport stream to the first receiving terminal 130.

The relay node 120 of FIG. 6 may be the same as or be easily inferred from the example embodiments described above with reference to FIGS. 1 through 5, and thus further detailed descriptions will be omitted here.

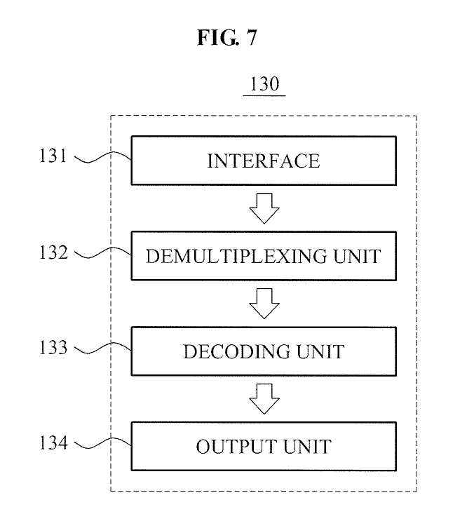

FIG. 7 is a block diagram illustrating a configuration of a receiving terminal according to an embodiment of the present invention. Here, the receiving terminal may be the first receiving terminal 130.

As illustrated in FIG. 7, the first receiving terminal 130 may include the interface 131, the demultiplexing unit 132, the decoding unit 133, and the output unit 134.

According to an embodiment of the present invention, the interface 131 may transmit display information to the relay node 120, and receive a customized transport stream from the relay node 120. The demultiplexing unit 132 may extract a customized ES from the customized transport stream. The decoding unit 133 may decode media data from the customized ES, and the output unit 134 may output the media data. In this instance, the relay node 120 may receive a transport stream including ESs from a transmitting terminal 110, select at least one customized ES from the ESs based on the display information, and generate the customized transport stream using the customized ES.

Also, the transmitting terminal 110 may receive media data, generate ESs from the media data, multiplex the ESs, and generate a transport stream. Also, the transmitting terminal 110 may transmit the transport stream to the relay node 120 associated with the first receiving terminal 130 among the receiving terminals.

According to an embodiment of the present invention, the interface 131 may transmit display information to the transmitting terminal 110, and receive a customized transport stream from the transmitting terminal 110. The demultiplexing unit 132 may extract a customized ES from the customized transport stream. The decoding unit 133 may decode media data from the customized ES, and the output unit 134 may output the media data. In this instance, the transmitting terminal 110 may generate a transport stream including ESs, select at least one customized ES from the ESs based on the display information, and generate the customized transport stream using the customized ES. Also, the transmitting terminal 110 may receive the media data and generate ESs from the media data.

The first receiving terminal 130 of FIG. 7 may be the same as or be easily inferred from the example embodiments described above with reference to FIGS. 1 through 6, and thus further detailed descriptions will be omitted here.

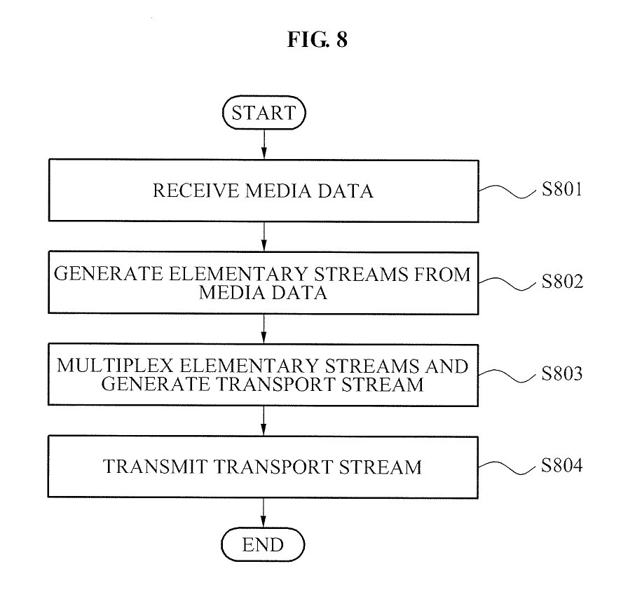

FIG. 8 is a flowchart illustrating a stream processing method according to an embodiment of the present invention.

As illustrated in FIG. 8, the stream processing method may be performed in operation S801 through operation S804. The input unit 111, the encoding unit 112, the multiplexing unit 113, and the interface 114 may be used for operation S801, operation S802, operation S803, and operation S804, respectively.

In operation 5801, the input unit 111 may receive media data. In this instance, the media data may include images from viewpoints different from each other. Also, the images may be any one of a 2D image, stereo images, and multi-view images.

Also, the input unit 111 may insert at least one of a virtual object and a virtual background in the media data.

In operation S802, the encoding unit 112 may generate ESs from the media data. In this instance, the media data may include images, and the ESs may be generated from the images. Also, the encoding unit 112 may generate the ESs based on display information of receiving terminals.

In operation S803, the multiplexing unit 113 may multiplex the ESs and generate a transport stream. In this instance, the multiplexing unit 113 may assign an identifier to each of the ESs to generate the transport stream.

Also, according to an embodiment of the present invention, the multiplexing unit 113 may multiplex the generated transport stream by multiplexing the ESs into transmission packets different from each other. Also, the multiplexing unit 113 may generate the transport stream by multiplexing the ESs into a single packet.

In operation S804, the interface 114 may transmit the transport stream to a relay node 120 associated with the first receiving terminal 130 among the receiving terminals.

In this instance, the relay node 120 may generate a customized transport stream from the transport stream based on display information of the first receiving unit 130. Here, the customized transport stream may include at least one of the ESs. Specifically, the relay node 120 may identify the ESs from the transport stream, and select at least one customized ES from the ESs based on the display information of the first receiving unit 130. Also, the relay node 120 may generate the customized transport stream using the customized ES. In this instance, the relay node 120 may generate the customized transport stream using the identifier.

Also, the customized transport stream may include at least one of an ES generated from a 2D image, ESs generated from stereo images, and ESs generated from multi-view images.

Also, the relay node 120 may periodically receive the display information from the first receiving terminal 130 in response to a request to the first receiving terminal 130 or in response to an occurrence of a predetermined event in the first receiving terminal 130. Also, the display information may include display device information and display setting information. Also, the display information may be determined based on a display output mode of the first receiving terminal 130.

Also, according to an embodiment of the present invention, the interface 114 may generate a customized transport stream from the transport stream based on the display information of the first receiving unit 130. The customized transport stream may include at least one of the ESs in operation S804.

The stream processing method of FIG. 8 may be the same as or be easily inferred from the example embodiments described above with reference to FIGS. 1 through 7, and thus further detailed descriptions will be omitted here.

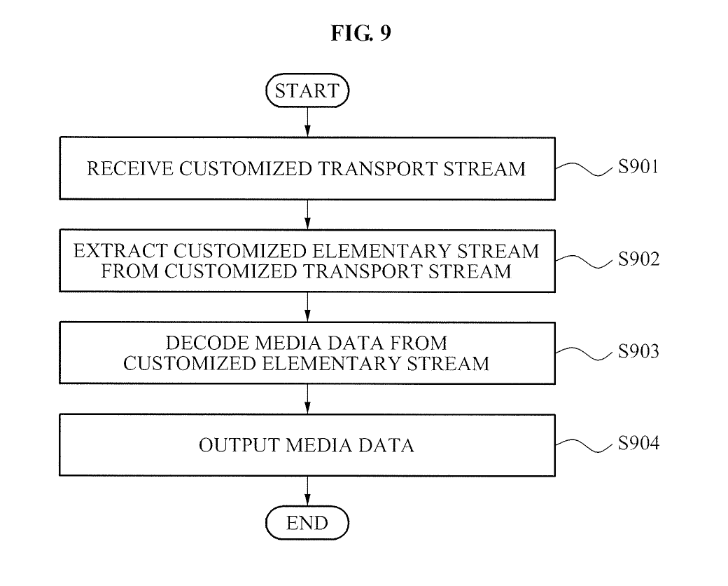

FIG. 9 is a flowchart illustrating a stream processing method according to another embodiment of the present invention.

As illustrated in FIG. 9, the stream processing method may be performed in operation S901 through operation S904. The interface 131, the demultiplexing unit 132, the decoding unit 133, and the output unit 134 may be used for operation S901, an operation S902, operation S903, and operation S904, respectively.

In operation S901, the interface 131 may transmit display information to a relay node 120, and receive a customized transport stream from the relay node 120. In operation S902, the demultiplexing unit 132 may extract a customized ES from the customized transport stream. In operation S903, the decoding unit 133 may decode media data from the customized ES. In operation S904, the output unit 134 may output the media data. In this instance, the relay node 120 may receive a transport stream including ESs from a transmitting terminal 110, select at least one customized ES from the ESs based on the display information, and generate the customized transport stream using the customized ES.

Also, according to an embodiment of the present invention, the interface 131 may transmit display information to the transmitting terminal 110, and receive a customized transport stream from the transmitting terminal 110 in operation S901. In operation S902, the demultiplexing unit 132 may extract a customized ES from the customized transport stream. In operation S903, the decoding unit 133 may decode media data from the customized ES. In operation S904, the output unit 134 may output the media data. In this instance, the transmitting terminal 110 may generate a transport stream including ESs, select at least one customized ES from the ESs based on the display information, and generate the customized transport stream using the customized ES.

The stream processing method of FIG. 9 may be the same as or be easily inferred from the example embodiments described above with reference to FIGS. 1 through 8, and thus further detailed descriptions will be omitted here.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A transmitting terminal, comprising:
an input unit to receive media data;
an encoding unit to generate elementary streams from the media data;
a multiplexing unit to multiplex the elementary streams and to generate a transport stream; and
an interface to transmit the transport stream to a relay node associated with a first receiving terminal among receiving terminals,
wherein a customized transport stream including at least one of the elementary streams is generated from the transport stream through the relay node based on display information of the first receiving terminal.

2. The transmitting terminal of claim 1, wherein the multiplexing unit assigns an identifier to each of the elementary streams.

3. The transmitting terminal of claim 2, wherein the customized transport stream is generated through the relay node using the identifier.

4. The transmitting terminal of claim 1, wherein the multiplexing unit multiplexes the elementary streams into transmission packets different from each other.

5. The transmitting terminal of claim 1, wherein the multiplexing unit multiplexes the elementary streams into a single packet.

6. The transmitting terminal of claim 1, wherein the media data includes images from different viewpoints, and the elementary streams are generated from the images.

7. The transmitting terminal of claim 6, wherein the images are any one of a two-dimensional (2D) image, stereo images, and multi-view images.

8. The transmitting terminal of claim 1, wherein the customized transport stream includes at least one of an elementary stream generated from a 2D image, elementary streams generated from stereo images, and elementary streams generated from multi-view images.

9. The transmitting terminal of claim 1, wherein the display information is periodically received from the first receiving terminal in response to a request to the first receiving terminal or in response to an occurrence of a predetermined event in the first receiving terminal.

10. The transmitting terminal of claim 1, wherein the display information includes display device information and display setting information.

11. The transmitting terminal of claim 1, wherein the display information is determined based on a display output mode of the first receiving terminal.

12. The transmitting terminal of claim 1, wherein the input unit inserts at least one of a virtual object and a virtual background in the media data.

13. The transmitting terminal of claim 1, wherein the encoding unit generates the elementary streams based on display information of the receiving terminals.

14. The transmitting terminal of claim 1, wherein, via the relay node, the elementary streams are identified from the transport stream, at least one customized elementary stream is selected from the elementary streams based on the display information of the first receiving terminal, and the customized transport stream is generated using the at least one customized elementary stream.

15. A transmitting terminal, comprising:
an input unit to receive media data;
an encoding unit to generate elementary streams from the media data;
a multiplexing unit to multiplex the elementary streams and to generate a transport stream; and
an interface to generate a customized transport stream including at least one of the elementary streams from the transport stream based on display information of a first receiving terminal among receiving terminals.

16. A relay node, comprising:
an information receiving unit to receive display information from a first receiving terminal among receiving terminals;
a stream receiving unit to receive a transport stream including elementary streams from a transmitting terminal;
a stream processing unit to generate a customized transport stream including at least one of the elementary streams from the transport stream based on the display information; and
a stream transmission unit to transmit the customized transport stream to the first receiving terminal.

17. The relay node of claim 16, wherein the stream processing unit identifies the elementary streams from the transport stream, selects at least one customized elementary stream from the elementary streams based on the display information of the first receiving terminal, and generates the customized transport stream using the customized elementary stream.

18. The relay node of claim 16, wherein the customized transport stream includes at least one of an elementary stream generated from a 2D image, elementary streams generated from stereo images, and elementary streams generated from multi-view images.

19. A receiving terminal, comprising:
an interface to transmit display information to a relay node, and to receive a customized transport stream from the relay node;
a demultiplexing unit to extract a customized elementary stream from the customized transport stream;
a decoding unit to decode media data from the customized elementary stream; and
an output unit to output the media data,
wherein, via the relay node, a transport stream including elementary streams is received from a transmitting terminal, at least one customized elementary stream is selected from the elementary streams based on the display information, and the customized transport stream is generated using the customized elementary stream.

20. A receiving terminal, comprising:
an interface to transmit display information to a transmitting terminal, and to receive a customized transport stream from the transmitting terminal;
a demultiplexing unit to extract a customized elementary stream from the customized transport stream;
a decoding unit to decode media data from the customized elementary stream; and
an output unit to output the media data,
wherein, via the transmitting terminal, a transport stream including elementary streams is generated, at least one customized elementary stream is selected from the elementary streams based on the display information, and the customized transport stream is generated using the customized elementary stream.
